(19) United States
(12) Patent Application Publication
(10) Pub. No.: US 2015/0138038 A1
(43) Pub. Date: May 21, 2015

(54) MULTI-SCREEN DISPLAY SYSTEM AND IMAGE SIGNAL CORRECTING METHOD FOR THE SAME

(71) Applicant: Electronics and Telecommunications Research Institute, Daejeon (KR)

(72) Inventors: Do Won NAM, Daejeon (KR); Bum Ho KIM, Daejeon (KR); Jeong Woo LEE, Daejeon (KR); Ki Song YOON, Daejeon (KR); Yeon Jeong JEONG, Daejeon (KR); Hyo Taeg JUNG, Daejeon (KR); Jung Soo LEE, Jeonju (KR); Sung Won MOON, Daejeon (KR)

(21) Appl. No.: 14/320,296

(22) Filed: Jun. 30, 2014

(30) Foreign Application Priority Data
Nov. 19, 2013 (KR) 10-2013-0140789

(51) Int. Cl. G06F 3/14

(52) U.S. Cl. CPC G06F 3/1446
USPC 345/1.3

(57) ABSTRACT

Disclosed are a multi-screen display system and a method of correcting a time synchronization of image signals respectively played by unit display panels. The multi-screen display system includes a multi-screen display apparatus configured to include a plurality of unit display panels and a timing sensing apparatus configured to sense, outside the multi-screen display apparatus, time synchronization information about the unit image frames respectively played by the unit display panels. The timing sensing apparatus calculates a time synchronization error between the unit image frames respectively played by the unit display panels, based on the time synchronization information, and transmits the time synchronization error to the multi-screen display apparatus.

### CROSS-REFERENCE TO RELATED APPLICATIONS

This application claims priority under 35 U.S.C. §119 to Korean Patent Application No. 10-2013-0140789, filed on Nov. 19, 2013, the disclosure of which is incorporated herein by reference in its entirety.

### TECHNICAL FIELD

The present invention relates to a multi-screen display system and an image signal correcting method for the same, and more particularly, to a technology that corrects a time synchronization of image signals played in a multi-screen by using a timing sensing apparatus.

### BACKGROUND

Generally, when an image display apparatus having a large screen is configured as a multi-screen type, the image display apparatus is configured by connecting a plurality of unit display apparatuses.

In a multi-screen display apparatus in which a plurality of unit display apparatuses are laterally, vertically connected to configure one screen as described above, the plurality of unit display apparatuses are arranged as a row×column matrix type.

In a case where the multi-screen display apparatus outputs one image, precise synchronization between display apparatuses configuring the multi-screen display apparatus is necessarily required in order for all screens of the multi-screen display apparatus to be viewed as one screen. At present, a method of synchronizing a plurality of screens is mainly using a method in which clocks respectively included in all display apparatuses (i.e., media players for playing an image in a display panel) are adjusted to match each other, and images are played according to a timing predetermined by each of the clocks.

FIG. 1 illustrates a related art image signal synchronizing method.

Referring to FIG. 1, in the related art image signal synchronization method, one time server is provided, and all display apparatuses (where, each of the display apparatuses includes a display panel and a media player, the display panel configuring a screen, and the media player that plays an image in the display panel) use a method that precisely adjusts a time according to a synchronization signal supplied from the time server, and then plays an image from a predetermined time. However, an image synchronization error occurs between screens for which clocks are precisely synchronized with each other.

Even in display apparatuses configured with the same hardware, an unpredictable delay occurs in actually playing an image in each of the display apparatuses, and due to the delay, an image timing mismatch occurs in a multi-screen display apparatus, causing a degradation in a whole quality of a multi-screen image.

Factors, which obstruct a synchronization of images played in the multi-screen display apparatus, include a transmission delay that occurs when a synchronization signal transmitted from the time server is transferred to a plurality of unit display apparatuses, a processing time difference that occurs in an operation of adjusting clocks respectively included in the unit display apparatuses according to the transmitted synchronization signal, a processing speed difference that occurs in actually playing an image, and a delay in hardware. Such problems are difficult to solve by using only the synchronization signal supplied from the time server, and due to the image timing mismatch between the unit display apparatuses, it is difficult to extend to the multi-screen display apparatus including the plurality of unit display apparatuses.

### SUMMARY

Accordingly, the present invention provides a method that corrects, by using a timing sensing apparatus, a time synchronization of image signals respectively played in a plurality of unit display apparatuses, thereby preventing an image timing mismatch between the unit display apparatuses from occurring.

The object of the present invention is not limited to the aforesaid, but other objects not described herein will be clearly understood by those skilled in the art from descriptions below.

In one general aspect, a multi-screen display system includes: a multi-screen display apparatus configured to include a plurality of unit display panels; and a timing sensing apparatus configured to sense, outside the multi-screen display apparatus, time synchronization information about the unit image frames respectively played by the unit display panels, wherein the timing sensing apparatus calculates a time synchronization error between the unit image frames respectively played by the unit display panels, based on the time synchronization information, and transmits the time synchronization error to the multi-screen display apparatus.

The multi-screen display apparatus may insert the time synchronization information into each of the unit image frames, and outputs unit image frames.

The time synchronization information may include position information of a unit display panel, which displays the time synchronization information, in the multi-screen display apparatus.

The time synchronization information may include unique information of the unit image frames.

The time synchronization information may include unit time information in which the unit image frames are played.

The time synchronization information may be inserted into the unit image frames as a watermark type.

The time synchronization information may be invisible to a user's eyes, and may be sensible by only the timing sensing apparatus.

The multi-screen display apparatus may include at least one or more image playing modules configured to synchronize and play the unit image frames respectively played by the unit display panels in consideration of the time synchronization error.

In another general aspect, a multi-screen display apparatus, including a plurality of unit display panels, includes: an image processor configured to classify unit image frames respectively played by the unit display panels; a time synchronization information inserting unit configured to insert corresponding time synchronization information into each of the unit image frames; and an image player configured to output a synchronized image signal by using a time synchronization error between the unit image frames which is calculated based on the time synchronization information by an external timing sensing apparatus.

In another general aspect, an image signal correcting method in a multi-screen display apparatus, including a plurality of unit display panels, includes: inserting corresponding time synchronization information into each of unit image frames respectively played by the unit display panels; receiving a time synchronization error between the unit image frames, which is calculated based on the time synchronization information, from an external timing sensing apparatus; and correcting, by using the time synchronization error, a view point of each of the unit image frames respectively played by the unit display panels.

Other features and aspects will be apparent from the following detailed description, the drawings, and the claims.

### BRIEF DESCRIPTION OF THE DRAWINGS

FIG. 1 is a diagram for describing a related art image signal synchronizing method.

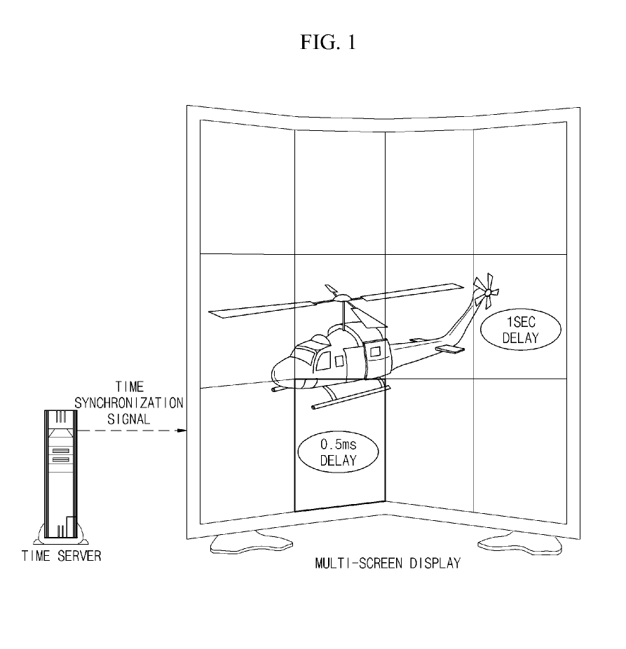

FIG. 2 is a diagram illustrating a configuration of a multi-screen display system according to an embodiment of the present invention.

FIG. 3 is a diagram illustrating an internal configuration of a multi-screen display apparatus of FIG. 2.

FIG. 4 is a diagram illustrating an image signal correcting method in a multi-screen display system according to another embodiment of the present invention.

### DETAILED DESCRIPTION OF EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims. In the following description, the technical terms are used only for explaining a specific exemplary embodiment while not limiting the present invention. The terms of a singular form may include plural forms unless specifically mentioned.

Hereinafter, exemplary embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

In a multi-screen display apparatus in which a plurality of unit display apparatuses are laterally, vertically connected to configure one screen, if it is technically difficult to fundamentally solve an image timing mismatch between the unit display apparatuses, a method of reducing the image timing mismatch as much as possible is needed. On the assumption that a time synchronization (timing) mismatch occurs between images respectively played by the unit display apparatuses in the multi-screen display apparatus, the present invention provides a method of correcting for the time synchronization (timing) mismatch.

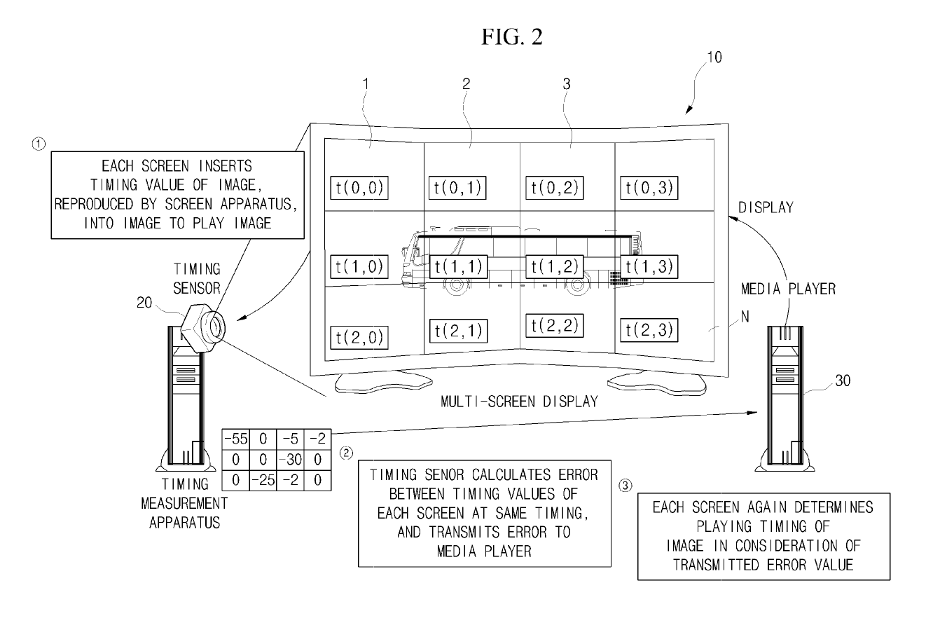

FIG. 2 is a diagram illustrating a configuration of a multi-screen display system according to an embodiment of the present invention in which an image signal correcting method proposed in the present invention is performed.

Referring to FIG. 2, the multi-screen display system according to the present invention includes a multi-screen display apparatus 10, in which a plurality of unit display panels 1 to n (where n is a natural number equal to or more than four) are laterally, vertically connected to configure one screen, and a timing sensing apparatus 20 that is provided outside the multi-screen display apparatus 10, and senses time synchronization information about a plurality of unit image frames respectively played by the unit display panels 1 to n.

Here, the timing sensing apparatus 20 calculates a time synchronization error between the unit image frames respectively played by the unit display panels 1 to n, based on the time synchronization information, and transmits the time synchronization error to the multi-screen display apparatus 10.

For example, the timing sensing apparatus 20 may be a high-speed camera which faces the multi-screen display apparatus 10. The timing sensing apparatus 20 continuously captures all images played by the multi-screen display apparatus 10 to measure how many timing errors each of the unit display panels 1 to n has, based on the time synchronization information included in the same image frame.

To provide a detailed description, it is unable to predict or control a time synchronization mismatch (which occurs in playing an image) between image frames played by the unit display panels in the multi-screen display apparatus 10, and thus, it is required to measure, outside the multi-screen display apparatus 10, the time synchronization mismatch by using an actually played image.

In the present invention, the timing sensing apparatus 20 for measuring a view point (time synchronization) of each image frame is provided outside the multi-screen display apparatus 10, and a time synchronization error between image frames which is measured by the timing sensing apparatus 20 is again fed back to the multi-screen display apparatus 10. The multi-screen display apparatus 10 adjusts an image view point in consideration of the feedback error value.

For example, it is assumed that in a state where all the unit display panels 1 to n are synchronized to the same time value by a time server, each image frame is played according to a time t1, a time t2, and a time t3 from a time t0.

Here, the multi-screen display apparatus 10 includes at least one or more image playing modules for playing unit images respectively displayed by the unit display panels 1 to n. One image playing module may play an image displayed by one unit display panel, or play images respectively displayed by a plurality of unit display panels. Generally, one image playing module may play an image displayed by one unit display panel.

For example, when there is no time synchronization error (a timing mismatch) between image frames, time synchronization values (timing values) of all display panel images (which are captured by the timing sensing apparatus 20 (for example, a high-speed camera) provided outside the multi-screen display apparatus 10) may be identically set to t0, t1, t2, and t3.

However, under a condition in which a timing mismatch occurs, timing values of some image frames are not matched like “t1+25 ms”, “t1−50 ms”, etc., and in particular, a large error in which an image frame corresponding to a time t2 or t3 is played at a time t1 occurs.

To solve such a problem, the timing sensing apparatus 20 according to the present invention senses time synchronization information about unit image frames respectively played by the display panels outside the multi-screen display apparatus 10, and calculates a time synchronization error between the unit image frames, based on the time synchronization information. Information about the time synchronization error is again transmitted to the multi-screen display apparatus 10, and each image playing module adjusts an image view point in consideration of the transmitted error value.

For example, each image playing module may store a corresponding image signal in a frame buffer for a predetermined delay time, based on the time synchronization error, and then, after the delay time elapses, each image playing module may output the image signal to a designated display panel. For example, when three display panels are provided and time synchronization information is “t1”, “t1+25 ms”, and “t1+50 ms” in the order of a left display panel 1, a right display panel 2, and a right display panel 3, an image playing module corresponding to number one display panel 1 stores a t2 image frame in a frame buffer thereof for +50 ms and then outputs the t2 image frame after a corresponding delay time elapses, and an image playing module corresponding to number two display panel 2 stores the t2 image frame in a frame buffer thereof for +25 ms and then outputs the t2 image frame after a corresponding delay time elapses.

In another embodiment, each image playing module may output a corresponding image signal to a corresponding display panel at a view point which is calculated by adding or subtracting the time synchronization error.

For example, when three display panels are provided and time synchronization information is “t1”, “t1+25 ms”, and “t1−50 ms” in the order of a left display panel 1, a right display panel 2, and a right display panel 3, an image playing module corresponding to number one display panel 1 outputs the t2 image frame to a corresponding display panel at a view point which is calculated by adding or subtracting an error of −25 ms, and an image playing module corresponding to number two display panel 2 outputs the t2 image frame to a corresponding display panel at a view point which is calculated by adding or subtracting an error of +50 ms.

In FIG. 2, it is illustrated that a play apparatus 30 provided independently from the multi-screen display apparatus 10 determines a unit image frame displayed by each of the unit display panels 1 to n and performs a time synchronization correcting operation, but an embodiment of the present invention is not limited thereto. In another embodiment of the present invention, the multi-screen display apparatus 10 may include an image playing module that performs a function of the play apparatus 30, and one or more image playing modules may control one unit display panel or a plurality of unit display panels as described above.

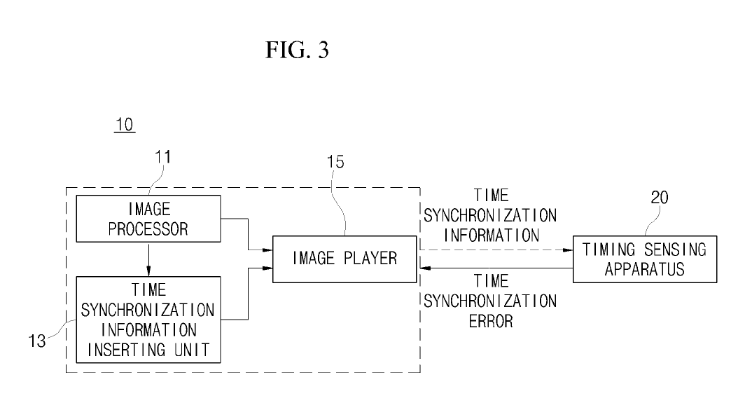

Hereinafter, the multi-screen display apparatus according to the present invention will be described in detail with reference to FIG. 3. FIG. 3 is a diagram illustrating an internal configuration of the multi-screen display apparatus of FIG. 2.

Referring to FIG. 3, the multi-screen display apparatus 10 according to the present invention includes an image processor 11, a time synchronization information inserting unit 13, and an image player 15.

The image processor 11 classifies unit image frames respectively played by the unit display panels 1 to n.

The time synchronization information inserting unit 13 inserts corresponding time synchronization information into each of the unit image frames.

When the multi-screen display apparatus 10 operates, each of the unit display panels 1 to n displays an image played according to predetermined time synchronization. At this time, the time synchronization information is inserted into image frames corresponding to the time synchronization in a type which is identifiable by the timing sensing apparatus 20.

Here, the time synchronization information may include row and column information about the plurality of unit display panels 1 to n configuring the multi-screen display apparatus 10 and position information of the unit display panels 1 to n displaying the information.

On the other hand, the time synchronization information may include unique information of the unit image frames, and may also include unit time information in which the unit image frames are played. Here, the unit time information may be displayed in units of millisecond (ms).

Depending on the case, the time synchronization information may be inserted into the unit image frames as a watermark type, and may be displayed as a type which is visible to a user's eyes. Alternatively, the time synchronization information may be inserted into the unit image frames as a type which is identifiable by the timing sensing apparatus 20 without being visible to a user's eyes. The type of the time synchronization information may be changed depending on an implementation method of the present invention.

The image player 15 respectively applies image frames, classified by the image processor 11, to the display panels 1 to n which are disposed at a corresponding position, thereby allowing a corresponding image frame to be displayed by a corresponding unit display panel.

In this case, the image player 15 outputs a synchronized image signal by using a time synchronization error between the unit image frames which is calculated based on the time synchronization information by the timing sensing apparatus 20.

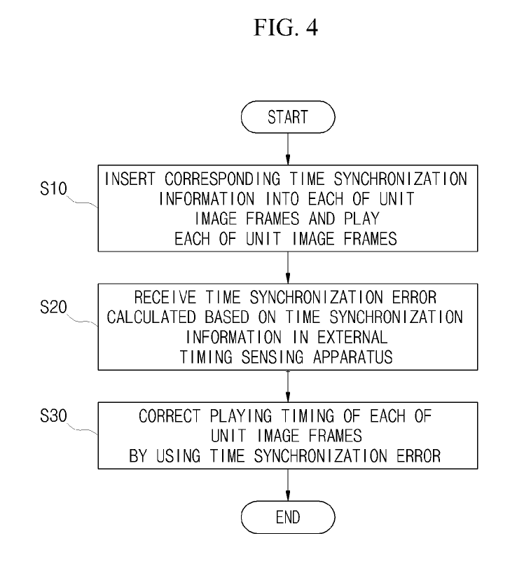

An operation of the multi-screen display system according to the present invention will be sequentially described with reference to FIG. 4.

FIG. 4 is a diagram illustrating an image signal correcting method in a multi-screen display system according to another embodiment of the present invention.

Referring to FIG. 4, in a multi-screen display apparatus including a plurality of unit display panels, time synchronization information corresponding to unit image frames respectively played by the unit display panels is first inserted into a corresponding unit image frame, and is played by each unit display panel, in operation S10. Here, the time synchronization information may include row and column information about the plurality of unit display panels configuring the multi-screen display apparatus and position information of the unit display panels displaying (or outputting) the information.

On the other hand, the time synchronization information may include unique information of the unit image frames, and may also include unit time information in which the unit image frames are played. Here, the unit time information may be displayed in units of millisecond (ms).

Depending on the case, the time synchronization information may be inserted into the unit image frames as a watermark type, and may be displayed as a type which is visible to a user's eyes. Alternatively, the time synchronization information may be inserted into the unit image frames as a type which is identifiable by an external timing sensing apparatus without being visible to a user's eyes. The type of the time synchronization information may be changed depending on an implementation method of the present invention.

In this state, the external timing sensing apparatus senses the time synchronization information to build a database of time synchronization information about the image frames respectively played by the unit display panels, and calculates a time synchronization error between unit image frames by using the time synchronization information.

For example, when the unit time information in which the unit image frames are displayed is displayed in units of millisecond (ms), the time synchronization information may be displayed in units of “t1+25 ms” or “t1−50 ms” for each of the unit image frames.

Subsequently, the external timing sensing apparatus calculates a time synchronization error by using the time synchronization information displayed by unit image frames. Here, information about the time synchronization error may include error information such as +25 ms and −50 ms, and may also include position information of a unit display panel in which each error is displayed.

The time synchronization error information is transmitted from the external timing sensing apparatus to the multi-screen display apparatus, and to this end, a wired or wireless network connection is established between the timing sensing apparatus and the multi-screen display apparatus, in operation S20.

Subsequently, by using the time synchronization error between the unit image frames, the multi-screen display apparatus corrects a view point of each of the unit image frames respectively played by the unit display panels, in operation S30.

As described above, the present invention corrects a time synchronization of image signals respectively played in the plurality of unit display apparatuses by using the timing sensing apparatus, thereby preventing an image timing mismatch between the unit display apparatuses from occurring.

The image signal correcting method according to the present invention may also be embodied as computer-readable codes on a computer-readable recording medium. The computer-readable recording medium is any data storage device that may store data which may be thereafter read by a computer system. Examples of the computer-readable recording medium include read-only memory (ROM), random access memory (RAM), CD-ROMs, magnetic tapes, floppy disks, and optical data storage devices. The computer-readable recording medium may also be distributed over network coupled computer systems so that the computer-readable code may be stored and executed in a distributed fashion.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multi-screen display system comprising:
a multi-screen display apparatus configured to include a plurality of unit display panels; and
a timing sensing apparatus configured to sense, outside the multi-screen display apparatus, time synchronization information about the unit image frames respectively played by the unit display panels,
wherein the timing sensing apparatus calculates a time synchronization error between the unit image frames respectively played by the unit display panels, based on the time synchronization information, and transmits the time synchronization error to the multi-screen display apparatus.

2. The multi-screen display system of claim 1, wherein the multi-screen display apparatus inserts the time synchronization information into each of the unit image frames, and outputs unit image frames.

3. The multi-screen display system of claim 1, wherein the time synchronization information comprises position information of a unit display panel, which displays the time synchronization information, in the multi-screen display apparatus.

4. The multi-screen display system of claim 1, wherein the time synchronization information comprises unique information of the unit image frames.

5. The multi-screen display system of claim 1, wherein the time synchronization information comprises unit time information in which the unit image frames are played.

6. The multi-screen display system of claim 1, wherein the time synchronization information are inserted into the unit image frames as a watermark type.

7. The multi-screen display system of claim 1, wherein the time synchronization information is invisible to a user's eyes, and is sensible by only the timing sensing apparatus.

8. The multi-screen display system of claim 1, wherein the multi-screen display apparatus comprises at least one or more image playing modules configured to synchronize and play the unit image frames respectively played by the unit display panels in consideration of the time synchronization error.

9. A multi-screen display apparatus, including a plurality of unit display panels, comprising:
an image processor configured to classify unit image frames respectively played by the unit display panels;
a time synchronization information inserting unit configured to insert corresponding time synchronization information into each of the unit image frames; and
an image player configured to output a synchronized image signal by using a time synchronization error between the unit image frames which is calculated based on the time synchronization information by an external timing sensing apparatus.

10. The multi-screen display apparatus of claim 9, wherein the time synchronization information comprises unit time information in which the unit image frames are played.

11. The multi-screen display apparatus of claim 9, wherein the time synchronization information comprises unique information of the unit image frames.

12. The multi-screen display apparatus of claim 9, wherein the time synchronization information are inserted into the unit image frames as a watermark type.

13. The multi-screen display apparatus of claim 9, wherein the time synchronization information is invisible to a user's eyes, and is sensible by only the timing sensing apparatus.

14. An image signal correcting method in a multi-screen display apparatus including a plurality of unit display panels, the image signal correcting method comprising:
inserting corresponding time synchronization information into each of unit image frames respectively played by the unit display panels;
receiving a time synchronization error between the unit image frames, which is calculated based on the time synchronization information, from an external timing sensing apparatus; and
correcting, by using the time synchronization error, a view point of each of the unit image frames respectively played by the unit display panels.
